(19) United States
(12) Patent Application Publication
(10) Pub. No.: US 2014/0057167 A1
(43) Pub. Date: Feb. 27, 2014

(54) SECONDARY BATTERY AND CARBON INK FOR CONDUCTIVE AUXILIARY LAYER OF THE SAME

(71) Applicants: NEC CORPORATION, Tokyo (JP); DIC CORPORATION, Tokyo (JP)

(72) Inventors: Masanori KASAI, Tokyo (JP); Hiroshi Isozumi, Tokyo (JP); Takayoshi Obata, Saitama (JP); Shigeyuki Iwasa, Tokyo (JP); Kentaro Nakahara, Tokyo (JP); Masahiro Suguro, Tokyo (JP)

(73) Assignees: NEC CORPORATION, Tokyo (JP); DIC CORPORATION, Tokyo (JP)

(21) Appl. No.: 14/068,332

(22) Filed: Oct. 31, 2013

Related U.S. Application Data
(62) Division of application No. 13/001,736, filed on Dec. 28, 2010.

(30) Foreign Application Priority Data
Jul. 3, 2008 (JP) 2008-174839

(51) Int. Cl. H01M 4/62

(52) U.S. Cl. CPC H01M 4/625
USPC 429/211

(57) ABSTRACT

A secondary battery using a polymer radical material and a conducting additive in which the performance of a conductive auxiliary layer is further improved and the internal resistance is reduced, thereby achieving a higher output. Specifically disclosed is a secondary battery in which at least one of a positive electrode and a negative electrode uses, as an electrode active material, a polymer radical material and a conducting additive having electrical conductivity. By providing a conductive auxiliary layer between a current collector and the polymer radical material/conducting additive electrode which is mainly composed of graphite, fibrous carbon or a granular carbon having a DBP absorption of not more than 110 cm³/100 g, the secondary battery with a higher output can be obtained.

### CROSS REFERENCE TO PRIOR APPLICATIONS

This is a divisional application of U.S. patent application Ser. No. 13/001,736, filed on Dec. 28, 2010, which is a U.S. National Phase application under 35 U.S.C. §371 of International Application No. PCT/JP2009/062222, filed on Jul. 3, 2009 and claims benefit of priority to Japanese Patent Application No. 2008-174839, filed on Jul. 3, 2008. The International Application was published in Japanese on Jan. 7, 2010 as WO 2010/002002 A1 under PCT Article 21(2). The contents of these applications are hereby incorporated by reference.

### TECHNICAL FIELD

The present invention relates to a secondary battery such as a lithium secondary battery, and in particular, relates to a secondary battery which uses a polymer radical material as an electrode active material.

### BACKGROUND ART

In recent years, along with the development of communications system, portable electronic equipment such as laptop computers and mobile phones has rapidly become common. While the performance of portable electronic equipment has been enhanced, their function, shape and the like have also been diversified. Accordingly, with respect to the batteries that serve as the power source therefor, various demands for their size reduction, weight reduction, high energy density, high power density and the like have been increasing.

The lithium ion batteries have been widely used since the 1990s as the batteries having a high energy density. The lithium ion batteries use, as the electrode active materials, lithium-containing oxides of transition metals such as lithium manganese oxide and lithium cobalt oxide in the positive electrode and carbon in the negative electrode, the charge and discharge thereof is carried out using the insertion or elimination reaction of the lithium ions into or from the electrode active materials. Since the lithium ion batteries exhibit a high energy density as well as superior recycle characteristics, they are used in various electronic equipment such as mobile phones. On the other hand, they have disadvantages in that a high output is difficult to achieve, and a long period of time is also required for charging them.

As the electrical storage devices capable of achieving a high output, electric double layer capacitors have been known. Since the electric double layer capacitors are capable of releasing a large current at once, a high output can be achieved. However, since their energy density is remarkably low and the size reduction thereof is also difficult, they are not suitable as the power source for many of the portable electronic equipment.

In addition, a non-aqueous electrolytic capacitor using a conductive polymer for the electrode material has also been proposed (see Patent Document 1). In this non-aqueous electrolytic capacitor, a high output can be achieved, and the energy density thereof is higher than that of the conventional electric double layer capacitor. However, as with the batteries using a conductive polymer as an electrode active material, there has been a limit for the concentration of generated dopants, and thus the obtained energy density has been low.

A secondary battery characterized in that the electrode active material of at least one of the positive electrode and negative electrode contains a radical material has been proposed in Patent Document 2, and an electrical storage device containing a nitroxyl polymer material within the positive electrode has also been proposed in Patent Document 3. It is considered that these electrical storage devices such as secondary batteries are capable of charging and discharging at a large current due to the rapid electrode reaction of the electrode active material (radical compound) itself, and thus a high output can be achieved.

Moreover, in Patent Document 4, the use of a current collector for positive electrodes in which a conductive auxiliary layer containing carbon as a major component thereof is integrally formed on an aluminum electrode has been proposed, in order to lower the internal resistance of the electrical storage device that contains a nitroxyl polymer as the electrode active material. In this electrical storage device, it is thought that the internal resistance thereof can be lowered and an even higher output can be achieved.

However, in the electrical storage device proposed in Patent Document 4, there is no mention of the effect of conductive auxiliary layer with respect to the types of carbon, and although the effect thereof is confirmed in terms of the film thickness, there is no mention of the effectiveness depending on the differences in the film thickness either. In addition, in the electrical storage device proposed in Patent Document 4, although a “conductive auxiliary layer” is defined as being integrally formed on an aluminum electrode, in order to clarify the definition, it is redefined herein as a “layer located between a current collector and a polymer radical material/conducting additive electrode and having carbon as a major component thereof”.

Output characteristics are represented by the product of electric current and electric voltage, and when focusing on the electric current, they are highly correlated with the rate characteristics which are represented by the relationship between the discharge current and the discharge efficiency. In the battery exhibiting high rate characteristics, it becomes possible to discharge at a large current, and thus high output characteristics can be achieved.

### PRIOR ART DOCUMENTS

### Patent Documents

[Patent Document 1] Japanese Unexamined Patent Application, First Publication No. 2000-315527
[Patent Document 2] Japanese Patent No. 3687736
[Patent Document 3] Japanese Unexamined Patent Application, First Publication No. 2002-304996
[Patent Document 4] WO 2005/078830

### DISCLOSURE OF THE INVENTION

### Problems to be Solved by the Invention

An object of the present invention is to provide a novel secondary battery which is a secondary battery using an electrode that includes a conducting additive and a polymer radical material, in which the performance of a conductive auxiliary layer is further improved and the reduction of the discharge capacity is low (i.e., the rate characteristics are high) even at a large current.

### Means for Solving the Problems

The present inventors have conducted intensive and extensive studies and completed the present invention as a result by discovering that a higher output can be achieved by providing a conductive auxiliary layer, which is mainly composed of graphite, fibrous carbon or specific granular carbon and positioned in between a current collector and the polymer radical material/conducting additive electrode.

That is, the present invention provides a secondary battery in which at least one of a positive electrode and a negative electrode uses, as an electrode active material, a polymer radical material and a conducting additive exhibiting electrical conductivity, the secondary battery comprising a conductive auxiliary layer provided between a current collector and the polymer radical material/conducting additive electrode which is mainly composed of any one of graphite, fibrous carbon or a granular carbon having a dibutyl phthalate (DBP) absorption (an index indicating the degree of association and aggregation of particles which is expressed by the level of DBP required to fill the gap between carbon particles) of not more than 110 cm³/100 g.

The present invention also provides a secondary battery wherein the conductive auxiliary layer is mainly composed of a granular carbon having a DBP absorption of not less than 30 cm³/100 g and not more than 110 cm³/100 g.

The present invention also provides a secondary battery wherein the mass ratio of graphite, fibrous carbon or a granular carbon having a DBP absorption of not more than 110 cm³/100 g of the conductive auxiliary layer is not less than 50% and not more than 95%.

The present invention also provides a secondary battery wherein the film thickness of the conductive auxiliary layer after drying is not more than 6 μm.

The present invention also provides a secondary battery wherein the polymer radical material is a polynitroxyl radical compound having a nitroxyl radical structure represented by a general formula (1) within a repeating unit:

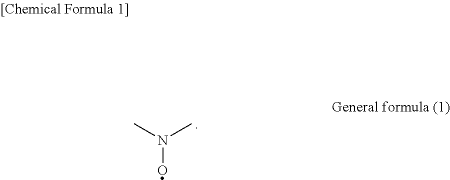

The present invention also provides a secondary battery wherein the polynitroxyl radical compound is poly(4-methacryloyloxy-2,2,6,6-tetramethylpiperidine-1-oxyl), poly(4-acryloyloxy-2,2,6,6-tetramethylpiperidine-1-oxyl), or a copolymer containing these as the components thereof.

The present invention also provides a secondary battery wherein the polynitroxyl radical compound is poly(4-vinyloxy-2,2,6,6-tetramethylpiperidine-1-oxyl) or a copolymer containing this as the component thereof.

The present invention also provides a secondary battery wherein the polynitroxyl radical compound has a cross-linked structure.

The present invention also provides a secondary battery wherein the secondary battery is a lithium secondary battery.

The present invention also provides a carbon ink for a conductive auxiliary layer of a secondary battery in which at least one of a positive electrode and a negative electrode uses, as an electrode active material, a polymer radical material and a conducting additive exhibiting electrical conductivity, the carbon ink for the conductive auxiliary layer to be used for forming the conductive auxiliary layer provided between a current collector and the polymer radical material/conducting additive electrode, the carbon ink comprising any one of graphite, fibrous carbon or a granular carbon having a DBP absorption of not more than 110 cm³/100 g.

### Effects of the Invention

According to the present invention, the internal resistance can be further reduced, and as a result, a secondary battery with a higher output can be achieved.

### BRIEF DESCRIPTION OF THE DRAWINGS

FIG. 1 is a perspective view showing an example of a secondary battery of the present invention.

FIG. 2 is an exploded perspective view showing an example of a constitution of the secondary battery of the present invention.

FIG. 3 is a comparison chart of rate characteristics due to the presence and absence of a conductive auxiliary layer.

FIG. 4 is a comparison chart of rate characteristics due to the difference in the carbon materials.

FIG. 5 is a comparison chart of rate characteristics due to the difference in the film thickness.

### BEST MODE FOR CARRYING OUT THE INVENTION

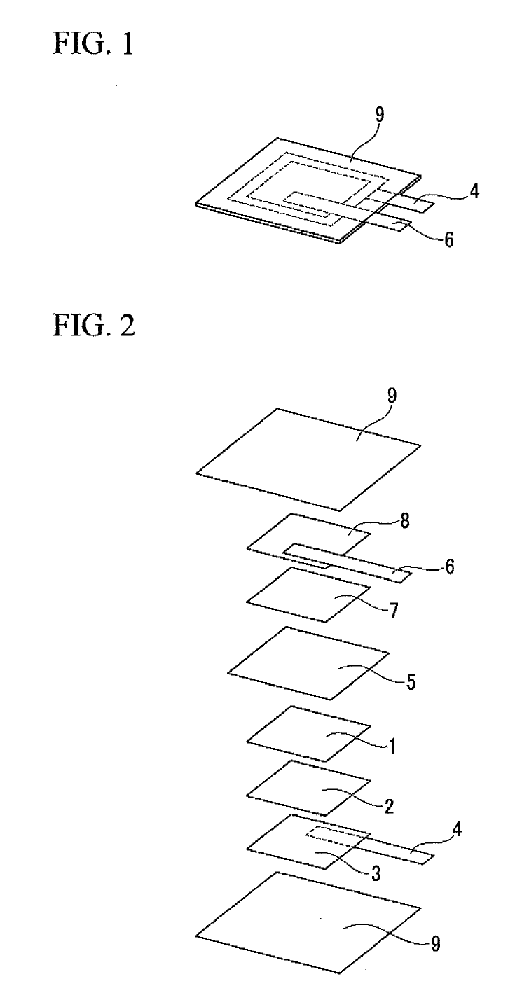

FIG. 1 is a perspective view showing an example of a secondary battery of the present invention. FIG. 2 is a perspective view showing an example of an exploded constitution of a secondary battery of the present invention. A battery shown in FIG. 2 has a constitution in which a conductive auxiliary layer 2 and a radical material/conducting additive positive electrode 1 that are formed on top of a positive electrode current collector (aluminum foil) 3 provided with a positive electrode lead 4 are superposed on, so as to oppose to, a negative electrode 7 disposed beneath a negative electrode current collector (metal foil) 8 provided with a negative electrode lead 6, via a separator 5 containing an electrolyte solution. These components are sealed with an exterior aluminum laminate (exterior packaging film) 9. Further, in those cases where a solid electrolyte or a gel electrolyte is used as an electrolyte solution, it can also be changed into a configuration in which these electrolytes are provided between the electrodes instead of the separator 5.

The secondary battery of the present invention is characterized by being provided with the conductive auxiliary layer 2, which is mainly composed of graphite, fibrous carbon or specific granular carbon, between the positive electrode 1, the negative electrode 7 or both electrodes and a current collector, in such a constitution. In view of achieving a higher output, it is preferable that the secondary battery of the present invention use an electrode that includes the above-mentioned conductive auxiliary layer as a positive electrode and use lithium or a compound inserted between the lithium layers such as carbon as a negative electrode.

The major components of the electrode in the secondary battery of the present invention are a polymer radical material and a conducting additive. In addition to these, other electrode active materials or conductive agents can be used in combination. Further, for the sake of increasing the stability of the electrode or making the preparation easy, a binder or a thickener can be added.

The major components of the conductive auxiliary layer in the secondary battery of the present invention are graphite, fibrous carbon or specific granular carbon and a binder. In addition to these, other conductive agents can be used in combination. Further, for the sake of increasing the stability of the conductive auxiliary layer or making the preparation easy, a thickener or other additives can be used.

### [1] Carbon for Conductive Auxiliary Layer

The carbon for conductive auxiliary layer to be used in the present invention is a major component of the conductive auxiliary layer and refers to a substance having a function to support the charge transfer between the current collector and the polymer radical material/conducting additive electrode.

At least one of graphite, fibrous carbon or a granular carbon having a DBP absorption of not more than 110 cm³/100 g (which is generally supplied for the coloring purpose) is essential as the aforementioned carbon for conductive auxiliary layer. Although any one of graphite, fibrous carbon or a granular carbon having a DBP absorption of not more than 110 cm³/100 g can be used alone as the carbon for conductive auxiliary layer to be used in the present invention, other carbon materials may be used in combination. The lower limit for the DBP absorption of granular carbon which can be substantially achieved is thought to be 30 cm³/100 g. Accordingly, the above-mentioned granular carbon to be used in the present invention has a DBP absorption of not more than 110 cm³/100 g, and preferably has a DBP absorption of not less than 30 cm³/100 g and not more than 110 cm³/100 g.

### [2] Polymer Radical Material

The polymer radical material to be used in the present invention functions as an electrode active material in the secondary battery and refers to a substance which directly contributes to the electrode reactions such as electric charge and discharge reactions. The polymer radical material is preferably a polymer radical material having a nitroxyl radical structure represented by the general formula (1) because of the high level of long-term stability as the radical per se and the high level of resistance with respect to repetitive oxidation reduction reactions.

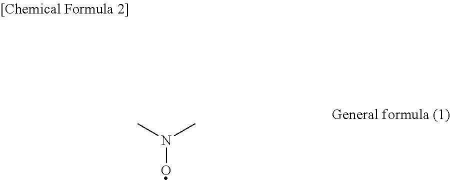

The nitroxyl radical material is a nitroxyl polymer compound that adopts a radical partial structure represented by the general formula (1) in a reduced state and adopts a nitroxyl cation partial structure represented by the general formula (2) in an oxidized state.

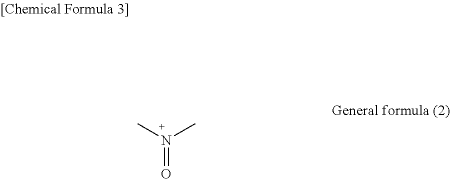

Such nitroxyl radical materials can be subjected to a repetitive electric charge and discharge through the reaction shown in the following reaction formula (A). The nitroxyl radical materials change the structure thereof from a nitroxyl radical structure to a nitroxyl cation structure during the electric charge and from a nitroxyl cation structure to a nitroxyl radical structure during the electric discharge.

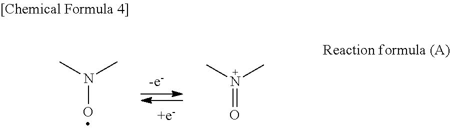

The reaction formula (A) represents an electrode reaction in the positive electrode, and the polymer radical material which involves such reactions can be made to function as a material for electrical storage device which accumulates and discharges electrons. Since the oxidation reduction reaction shown in the reaction formula (A) is a reaction mechanism which is not associated with the structural change of the organic compounds, the reaction rate is high, and thus a large electric current can be applied at a time if an electrical storage device is constituted using this polymer radical material as an electrode material.

In the present invention, as the nitroxyl polymer compounds, in view of the long term stability, those having a radical selected from the group consisting of a piperidinoxyl radical represented by the general formula (3), pyrrolidinoxyl radical represented by the general formula (4), and pyrrolinoxyl radical represented by the general formula (5) within the structure thereof are preferred, and those having a 2,2,6,6-tetramethylpiperidinoxyl radical represented by the general formula (6), a 2,2,5,5-tetramethylpyrrolidinoxyl radical represented by the general formula (7), or a 2,2,5,5-tetramethylpyrrolinoxyl radical structure represented by the general formula (8) are more preferred.

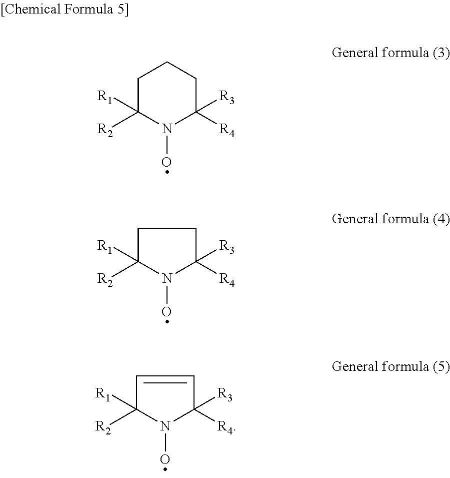

In the general formulas (3), (4) and (5), R₁ to R₄ represent an alkyl group of 1 to 4 carbon atoms.

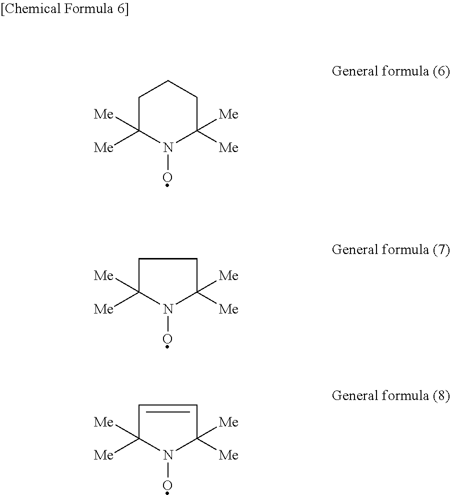

In the general formulas (6), (7) and (8), Me represents a methyl group.

Examples of the main chain polymer structure in the aforementioned nitroxyl polymer compounds include polyalkylene-based polymers such as polyethylene, polypropylene, polybutene, polydecene, polydodecene, polyheptene, polyisobutene, and polyoctadecene; diene-based polymers such as polybutadiene, polychloroprene, polyisoprene, and polyisobutene; poly(meth)acrylic acid; poly(meth)acrylonitrile; poly(meth)acrylamide polymers such as poly(meth)acrylamide and polymethyl(meth)acrylamide and polydimethyl(meth)acrylamide and polyisopropyl(meth)acrylamide;

polyalkyl(meth)acrylates such as polymethyl(meth)acrylate, polyethyl(meth)acrylate and polybutyl(meth)acrylate; fluorine-based polymers such as polyvinylidene fluoride and polytetrafluoroethylene; polystyrene-based polymers such as polystyrene, polybromostyrene, polychlorostyrene and polymethylstyrene; and vinyl-based polymers such as polyvinyl acetate, polyvinyl alcohol, polyvinyl chloride, polyvinyl methyl ether, polyvinyl carbazole, polyvinyl pyridine and polyvinylpyrrolidone;

polyether-based polymers such as polyethylene oxide, polypropylene oxide, polybutene oxide, polyoxymethylene, polyacetaldehyde, polymethyl vinyl ether, polypropyl vinyl ether, polybutyl vinyl ether and polybenzyl vinyl ether; polysulfide-based polymers such as polymethylene sulfide, polyethylene sulfide, polyethylene disulfide, polypropylene sulfide, polyphenylene sulfide, polyethylene tetrasulfide and polyethylene trimethylene sulfide;

polyesters such as polyethylene terephthalate, polyethylene adipate, polyethylene isophthalate, polyethylene naphthalate, polyethylene paraphenylene diacetate and polyethylene isopropylidene dibenzoate; polyurethanes such as polytrimethylene ethylene urethane; polyketone-based polymers such as polyether ketone and polyallylether ketone; polyanhydride-based polymers such as polyoxyisophthaloyl; polyamine-based polymers such as polyethyleneamine, polyhexamethyleneamine and polyethylenetrimethyleneamine; polyamide-based polymers such as nylon, polyglycine and polyalanine; polyimine-based polymers such as polyacetyliminoethylene and polybenzoyliminoethylene; polyimide-based polymers such as polyesterimide, polyetherimide, polybenzimide and polypyrromelimide;

polyaromatic polymers such as polyallylene, polyallylene alkylene, polyallylene alkenylene, polyphenol, phenolic resin, cellulose, polybenzimidazole, polybenzothiazole, polybenzoxazine, polybenzoxazole, polycarborane, polydibenzofuran, polyoxyisoindoline, polyfuran tetracarboxylic acid diimide, polyoxadiazole, polyoxindole, polyphthalazine, polyphthalide, polycyanurate, polyisocyanurate, polyppiperazine, polypiperidine, polypyrazinoquinoxane, polypyrazole, polypyridazine, polypyridine, polypyromellitimine, polyquinone, polypyrrolidine, polyquinoxaline, polytriazine and polytriazole; siloxane-based polymers such as polydisiloxane and polydimethylsiloxane; polysilane-based polymers; polysilazane-based polymers; polyphosphazene-based polymers; polythiazyl-based polymers; and conjugated polymers such as polyacetylene, polypyrrole and polyaniline. The term “(meth)acryl” means either methacryl or acryl.

Among these, it is preferable to include polyalkylene-based polymers, poly(meth)acrylates, poly(meth)acrylamides and polystyrene-based polymer as a main chain structure in view of attaining superior electrochemical resistance.

It is more preferable that examples of the units included in the nitroxyl polymer favorably used in the secondary battery of the present invention include poly(4-methacryloyloxy-2,2,6,6-tetramethylpiperidine-1-oxyl) represented by the general formula (9), poly(4-acryloyloxy-2,2,6,6-tetramethylpiperidine-1-oxyl) represented by the general formula (10), poly(4-vinyloxy-2,2,6,6-tetramethylpiperidine-1-oxyl) represented by the general formula (11), or a copolymer or crosslinked polymer which contains these compounds as the components thereof.

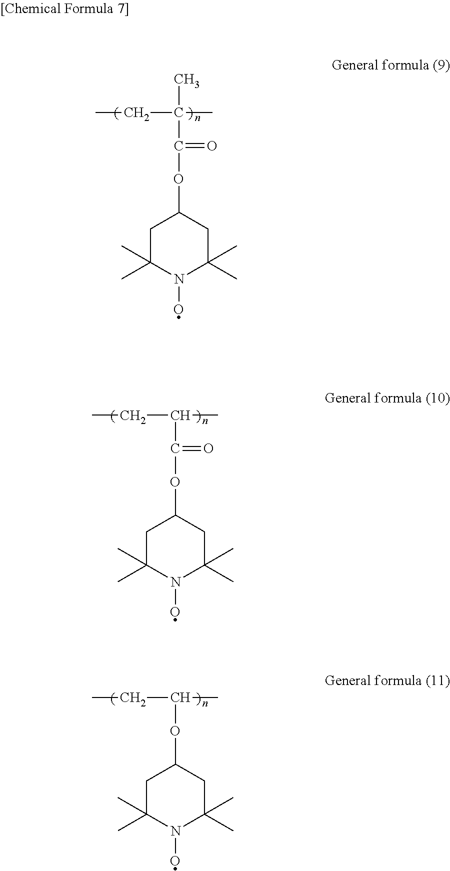

Although the molecular weight of the nitroxyl polymer compound used in the secondary of the present invention is not particularly limited, it is preferable to have a molecular weight so that when constituting an electrical storage device, the compound becomes poorly soluble in the electrolyte thereof. This differs depending on the types and combinations of the organic solvents in the electrolyte. In general, the weight average molecular weight is not less than 1,000, preferably not less than 10,000, and particularly preferably not less than 20,000. In addition, the upper limit thereof is not more than 5,000,000, and preferably not more than 500,000. Further, the polymer radical material may be cross-linked, and since the solubility in the electrolyte can be reduced as a result of the crosslink, durability with respect to the electrolyte solution can be improved.

In addition, with respect to the electrode active material of one pole in the battery of the present invention, although the polymer radical material used in the present invention can be used alone, it may also be used in combination with other electrode active materials. In this case, the polymer radical material used in the present invention is preferably included within the electrode active material from 10 to 90% by mass, and more preferably from 20 to 80% by mass.

In the secondary battery of the present invention, when the polymer radical material is used in a positive electrode, metal oxides, disulfide compounds, other stable radical compounds, conductive polymers or the like can be used in combination as other electrode active materials. Examples of the metal oxides include lithium manganese oxide or lithium manganese oxide having a spinel structure such as LiMnO₂, LiₓMn₂O₄ (0<x<2), MnO₂, LiCoO₂, LiNiO₂ and Li_{y}V₂O₅ (0<y<2), olivine-type materials such as LiFePO₄, and materials in which Mn within the spinel structure has been partially substituted with other transition metals such as LiNi_{0.5}Mn_{1.5}O₄, LiCr_{0.5}Mn_{1.5}O₄, LiCo_{0.5}Mn_{1.5}O₄, LiCoMnO₄, LiNi_{0.5}Mn_{0.5}O₂, LiNi_{0.33}Mn_{0.33}Co_{0.33}O₂, LiNi_{0.8}Co_{0.2}O₂, LiN_{0.5}Mn_{1.5-z}Ti_{z}O₄ (0<z<1.5).

Examples of the disulfide compounds include dithioglycol, 2,5-dimercapto-1,3,4-thiadiazole, and S-triazine-2,4,6-trithiol.

Examples of other stable radical compounds include 2,2-diphenylpicryl-1-hydrazyl and galvinoxyl.

In addition, examples of the conductive polymers include polyacetylene, polyphenylene, polyaniline, and polypyrrole.

Among these, it is particularly preferable to combine with lithium manganese oxide or LiCoO₂. In the present invention, these other electrode active materials can be used either alone or in combination of two or more kinds thereof.

In the secondary battery of the present invention, in those cases where a polymer radical material is used in the negative electrode, graphite, amorphous carbon, lithium alloys, conductive polymers or the like can be used, although there are no particular limitations on other electrode active materials. In addition, other stable radical compounds may be used. There are no particular limitations on the shape of these materials. For example, in case of the lithium metal, the material may not only be in the form of a film, but also in a bulky form, a form of a solidified powder, a fibrous form, a flaked form or the like. Among these, it is particularly preferable to combine with a lithium metal or graphite. In addition, these other electrode active materials can be used either alone or in combination of two or more kinds thereof

The secondary battery of the present invention uses the polymer radical material employed in the present invention as an electrode active material in either one of the positive electrode and negative electrode or in both electrodes. However, in those cases where the aforementioned polymer radical material is used only in one of the electrodes as an electrode active material, the electrode active materials as exemplified above can be used as the electrode active material in the other electrode. These electrode active materials can be used either alone or in combination of two or more kinds thereof. Further, at least one of these electrode active materials can be used in combination with the aforementioned polymer radical material. In addition, the aforementioned polymer radical material can also be used alone.

In the secondary battery of the present invention, the electrode using the electrode active material is not limited to either one of the positive electrode and negative electrode as long as the polymer radical material is directly involved in the electrode reaction in the positive electrode or negative electrode. However, in view of energy density, it is particularly preferable to use this polymer radical material as an electrode active material of the positive electrode. In this case, it is preferable to use this polymer radical material alone as the positive electrode active material. However, it is also possible to use in combination with other positive electrode active material, and lithium manganese oxide or LiCoO₂ is preferred as the other positive electrode active material. Furthermore, when using the above-mentioned positive electrode active material, it is preferable to use a lithium metal or graphite as a negative electrode active material.

### [3] Conducting Additive

Examples of the conducting additives include carbon materials such as activated carbon, graphite, carbon black, acetylene black and carbon fibers and conductive polymers such as polyacetylene, polyphenylene, polyaniline and polypyrrole. Carbon fibers are particularly preferred, and as the carbon fibers, those having an average fiber diameter of 50 nm to 300 nm are more preferred.

### [4] Binder

A binder can also be used in order to reinforce the bindings between each of the materials constituting the electrode. Examples of such a binder include polytetrafluoroethylene, polyvinylidene fluoride, a vinylidene fluoride-hexafluoropropylene copolymer, a vinylidene fluoride-tetrafluoroethylene copolymer, a styrene-butadiene rubber copolymer, and resin binders such as polypropylene, polyethylene, polyimide and various polyurethanes. These binders can be used either alone or as a mixture of two or more kinds thereof. The ratio of the binder within an electrode is preferably from 5 to 30% by mass. In addition, the ratio of the binder within the conductive auxiliary layer is preferably from 5 to 50% by mass.

### [5] Thickener

A thickener can also be used in order to make the preparation of electrode slurry which serves as a dispersing element of the polymer radical material easy. Examples of such thickeners include carboxymethyl cellulose, polyethylene oxide, polypropylene oxide, hydroxyethyl cellulose, hydroxypropyl cellulose, carboxymethyl hydroxyethyl cellulose, polyvinyl alcohol, polyacrylamide, hydroxyethyl polyacrylate, ammonium polyacrylate and polyacrylic acid soda. These thickeners can be used either alone or as a mixture of two or more kinds thereof. The ratio of the thickener within an electrode is preferably from 0.1 to 10% by mass.

### [6] Catalyst

The secondary battery of the present invention can also use a catalyst that promotes the oxidation-reduction reaction in order to carry out the electrode reaction more smoothly. Examples of such catalysts include conductive polymers such as polyaniline, polypyrrole, polythiophene, polyacetylene and polyacene; basic compounds such as pyridine derivatives, pyrrolidone derivatives, benzimidazole derivatives, benzothiazole derivatives and acridine derivatives; and metal ion complexes. These catalysts can be used either alone or as a mixture of two or more kinds thereof. The ratio of the catalyst within an electrode is preferably not more than 10% by mass.

### [7] Current Collector and Separator

As a negative electrode current collector and a positive electrode current collector, nickel, aluminum, copper, gold, silver, an aluminum alloy, stainless steel, carbon or the like can be used in the form of a foil, a metal plate or mesh. In terms of potential stability, an aluminum foil and a copper foil are particularly preferable as the positive electrode current collector and the negative electrode current collector, respectively. A current collector may exhibit a catalytic effect or may chemically bind with an electrode active material.

On the other hand, it is also possible to use a separator made of a porous film, a nonwoven fabric or the like which is composed of polyethylene, polypropylene, or the like, so that the above-mentioned positive electrode and negative electrode do not come into contact.

### [8] Electrolyte

In the secondary battery of the present invention, an electrolyte carries out the transfer of charged carriers between the electrodes, i.e., the negative electrode and the positive electrode, and, in general, it is preferable to exhibit an ion conductivity of 10⁻⁵ to 10⁻¹ S/cm at 20° C. As an electrolyte, for example, an electrolyte solution prepared by dissolving an electrolyte salt in a solvent can be used. As an electrolyte salt, conventionally known materials such as LiPF₆, LiClO₄, LiBF₄, LiCF₃SO₃, Li(CF₃SO₂)₂N, Li(C₂F₅SO₂)₂N, Li(CF₃SO₂)₃C and Li(C₂F₅SO₂)₃C can be used. These electrolyte salts can be used either alone or as a mixture of two or more kinds thereof. As described above, it is preferred that the secondary battery of the present invention be a lithium secondary battery.

In addition, when using a solvent for the electrolyte solution, as the solvent, for example, organic solvents such as ethylene carbonate, propylene carbonate, dimethyl carbonate, diethyl carbonate, methyl ethyl carbonate, γ-butyrolactone, tetrahydrofuran, dioxolane, sulfolane, N,N-dimethylformamide, N,N-dimethylacetamide and N-methyl-2-pyrrolidone can be used. These solvents can be used either alone or as a mixture of two or more kinds thereof.

Further, in the secondary battery of the present invention, a solid electrolyte can also be used as an electrolyte. Examples of the polymer compounds used in the solid electrolyte include vinylidene fluoride-based polymers such as polyvinylidene fluoride, a vinylidene fluoride-hexafluoropropylene copolymer, a vinylidene fluoride-ethylene copolymer, a vinylidene fluoride-monofluoroethylene copolymer, a vinylidene fluoride-trifluoroethylene copolymer, a vinylidene fluoride-tetrafluoroethylene copolymer and a vinylidene fluoride-hexafluoropropylene-tetrafluoroethylene terpolymer; acrylonitrile-based polymers such an acrylonitrile-methyl methacrylate copolymer, an acrylonitrile-methyl acrylate copolymer, an acrylonitrile-ethyl methacrylate copolymer, an acrylonitrile-ethyl acrylate copolymer, an acrylonitrile-methacrylic acid copolymer, an acrylonitrile-acrylic acid copolymer and an acrylonitrile-vinyl acetate copolymer; polyethylene oxide, an ethylene oxide-propylene oxide copolymer, and acrylate or methacrylate polymers thereof. A gel form prepared by including an electrolyte solution in these polymer compounds may be used, or a polymer compound alone which includes an electrolyte salt may be used as it is.

### [9] Preparation of Conductive Auxiliary Layer

There are no particular limitations on the method for preparing a conductive auxiliary layer, and a method appropriately selected in accordance with the material can be used. In the most common preparation method, the aforementioned binder and solvent are mixed with graphite, fibrous carbon or specific granular carbon and then stirred, thereby preparing a uniform dispersion liquid in the form of a slurry to be used as a carbon ink for conductive auxiliary layer. The carbon ink is applied onto an electrode current collector and the solvent is then volatilized by heating or at the normal temperature, thereby obtaining a conductive auxiliary layer. The mass ratio of graphite, fibrous carbon or specific granular carbon in the conductive auxiliary layer is preferably not less than 50% and not more than 95%. Examples of the solvent for preparing a slurry include ether-based solvents such as tetrahydrofuran, diethyl ether, ethylene glycol dimethyl ether and dioxane; amine-based solvents such as N,N-dimethylformamide and N-methylpyrrolidone; aromatic hydrocarbon-based solvents such as benzene, toluene and xylene; aliphatic hydrocarbon-based solvents such as hexane and heptane; halogenated hydrocarbon-based solvents such as chloroform, dichloromethane, dichloroethane, trichloroethane and carbon tetrachloride; alkyl ketone-based solvents such as acetone and methyl ethyl ketone; alcohol-based solvents such as methanol, ethanol and isopropyl alcohol; dimethyl sulfoxide and water.

In the process of preparing a conductive auxiliary layer by employing the above-mentioned dispersion and applying it onto an electrode current collector and drying, although a method to be used is not particularly limited, a printing method or a coating method can be used. For example, a screen printing method, a rotary screen printing method, a gravure printing method, a gravure offset printing method, a flexographic printing method, a die coating method, a cap coating method, a roll coating method or the like can be used, and of these, a gravure printing method, a gravure offset printing method or a flexographic printing method is more preferred. The thickness of coating film following the application and drying is preferably not more than 6 μm, and more preferably not more than 2 μm.

### [10] Preparation of Electrode

There are no particular limitations on the method for preparing an electrode, and a method appropriately selected in accordance with the material can be used. Examples of the most commonly adopted preparation method include a method in which the aforementioned conducting additive, binder and solvent are mixed with the polymer radical material and then stirred, thereby preparing a uniform dispersion liquid in the form of a slurry. The dispersion liquid is applied onto an electrode current collector and the solvent is then volatilized by heating or at the normal temperature, thereby obtaining an electrode. Examples of the solvent for preparing a slurry include ether-based solvents such as tetrahydrofuran, diethyl ether, ethylene glycol dimethyl ether and dioxane; amine-based solvents such as N,N-dimethylformamide and N-methylpyrrolidone; aromatic hydrocarbon-based solvents such as benzene, toluene and xylene; aliphatic hydrocarbon-based solvents such as hexane and heptane; halogenated hydrocarbon-based solvents such as chloroform, dichloromethane, dichloroethane, trichloroethane and carbon tetrachloride; alkyl ketone-based solvents such as acetone and methyl ethyl ketone; alcohol-based solvents such as methanol, ethanol and isopropyl alcohol; dimethyl sulfoxide and water. In the process of preparing a positive electrode or a negative electrode by employing the above-mentioned dispersion and applying it onto an electrode current collector, although a method to be used is not particularly limited, a printing method or a coating method can be used. For example, a screen printing method, a rotary screen printing method, a gravure printing method, a gravure offset printing method, a flexographic printing method, a die coating method, a cap coating method, a roll coating method or the like can be used, and of these, a screen printing method or a rotary screen printing method is more preferred.

Further, when preparing an electrode, there are cases where the polymer radical material per se used in the present invention is used as an electrode active material and where a polymer which changes into the polymer radical material used in the present invention by the electrode reaction is used as an electrode active material. Examples of such a polymer which changes into the above-mentioned polymer radical material by the electrode reaction include lithium salts and sodium salts that are composed of an anionic form prepared by reducing the above-mentioned polymer radical material and electrolyte cations such as lithium ions and sodium ions, or salts that are composed of a cationic form prepared by oxidizing the above-mentioned polymer radical material and electrolyte anions such as PF₆⁻ and BF₄⁻.

### [11] Battery Shape

In the secondary battery of the present invention, the shape of the battery is not particularly limited. Examples of the battery shape include an electrode laminate or a rolled body which is sealed in a metal case, a resin case or a laminate film made of a metal foil such as aluminum foil and a synthetic resin film, and it may be prepared into a cylindrical form, a prismatic form, a coin form, a sheet form or the like, although the battery shape in the present invention is not limited thereto.

### [12] Method of Producing Battery

Examples of the methods include a method in which electrodes are placed opposite to each other (opposite arrangement) and while having a separator interposed therebetween, are either laminated or rolled with an exterior material, followed by the injection of an electrolyte solution thereto and sealing. When manufacturing a battery, there are cases where the polymer radical material per se is used as an electrode active material to manufacture a battery and where a polymer which changes into the polymer radical material used in the present invention by the electrode reaction is used as an electrode active material to manufacture a battery.

In the secondary battery of the present invention, a conventionally known method can be used for manufacturing a battery with respect to other manufacturing conditions such as the extraction of a lead from the electrode and the exterior packaging.

### EXAMPLES

Although the following provides a more detailed explanation of the present invention using synthetic examples and examples thereof, the present invention is no way limited thereto.

### Example 1

90 parts of N-methyl-2-pyrrolidinone (NMP) serving as a solvent were added to 10 parts of polyvinylidene fluoride (PVDF) (Kureha KF #1300, hereafter referred to as “PVDF”), and the PVDF was completely dissolved using a dispersion stirrer in advance to prepare a 10% PVDF solution. 1.23 g of a granular carbon (#25: manufactured by Mitsubishi Chemical Corporation and having a DBP absorption of 69 cm³/100 g) and 5.25 g of the 10% PVDF solution were added to 18.52 g of NMP, and the mixture was then dispersed using a bead mill, thereby obtaining a carbon ink for conductive auxiliary layer. The obtained carbon ink was applied uniformly onto an aluminum foil using a draw down rod and dried, thereby obtaining a conductive auxiliary layer having a film thickness of 1 μm.

0.9 g of poly(4-methacryloyloxy-2,2,6,6-tetramethylpiperidine-1-oxyl) (hereafter, referred to as “PTMA”) which corresponds to the polymer radical material represented by the aforementioned general formula (9) and 3 g of the 10% PVDF solution were added to 24.3 g of NMP, and the mixture was then dispersed sufficiently using a dispersion stirrer, thereby obtaining a polymer radical dispersion liquid. Thereafter, 1.8 g of carbon fibers, i.e., carbon nanofiber VGCF (hereafter, referred to as “VGCF”, manufactured by Showa Denko K.K.) serving as a conducting additive was added thereto and the mixture was then stirred until a uniform dispersion was obtained using a dispersion stirrer, thereby yielding an ink for electrode. The obtained ink for electrode was applied onto the conductive auxiliary layer, which was prepared as described above, by the mimeograph printing (using a screen printing machine LS-150 manufactured by Newlong Seimitsu Kogyo Co., Ltd.) using a metal mask (stencil) and then dried using a vacuum oven, followed by a pressing process, thereby obtaining a positive electrode having a dimension of 25 mm (width)×16 mm (length).

An aluminum lead having a length of 65 mm and a width of 0.4 mm was welded onto the aluminum foil surface of this positive electrode. In addition, lithium laminated copper foil (lithium thickness of 30 μm) was perforated into a rectangle having a dimension of 25 mm×16 mm in the same manner as the positive electrode to produce a negative electrode of metal lithium, and a nickel lead having a length of 65 mm and a width of 0.4 mm was welded onto the copper foil surface. The positive electrode, porous polypropylene separator (of a rectangular shape having a dimension of 30 mm×20 mm) and negative electrode were superposed in this order so that the radical positive electrode layers and metal lithium negative electrode were opposed with each other to prepare an electrical storage body. Three ends of the two pieces of heat sealable aluminum laminate films (58 mm (length)×52 mm (width)×0.12 mm (thickness)) were heat sealed so as to prepare a saclike case, and the electrical storage body was placed therein. Further, an electrolyte solution [an ethylene carbonate/diethyl carbonate mixed solution (mixing ratio of 3:7 in terms of volume) containing a LiPF₆ electrolyte salt at a concentration of 1.0 mol/L] was injected into the aluminum laminate case described above.

During this process, 2.7 cm of the ends of the electrodes equipped with an aluminum or nickel lead was placed outside, and one unsealed end of the aluminum laminate case was heat sealed thereto under a low pressure of 1.6 mmHg. As a result, the electrodes and electrolyte solution were completely sealed in the aluminum laminate case. A thin organic radical battery (58 mm (length)×52 mm (width)×0.3 mm (thickness)) was prepared as described above.

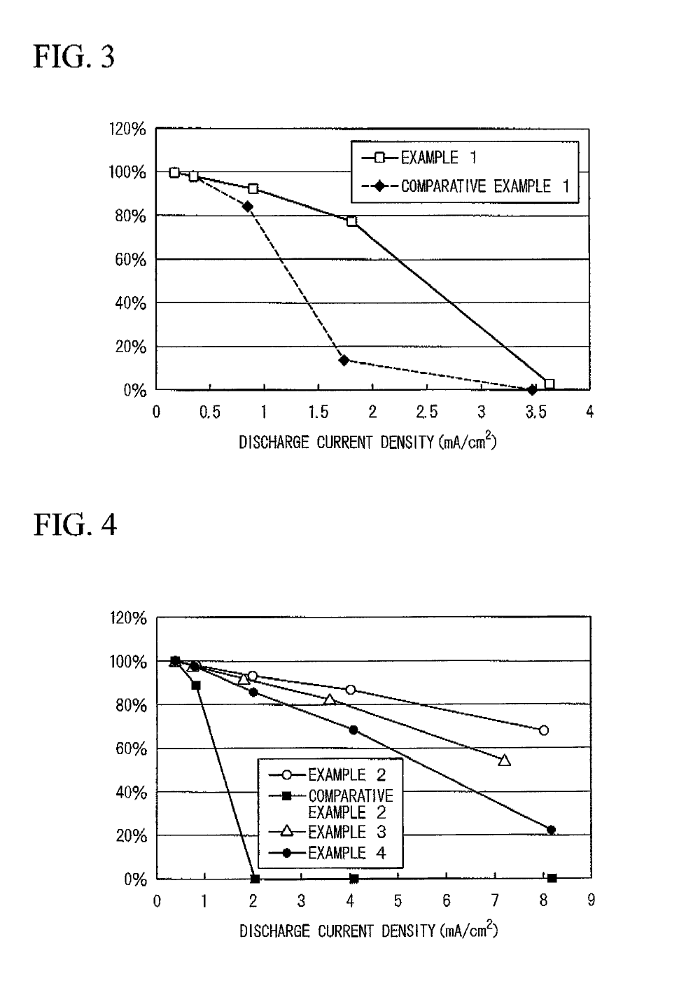

This battery of Example 1 provided with a conductive auxiliary layer was charged at 1C, and the discharge capacity thereof when discharged at 1C was measured. Thereafter, the discharge capacities thereof when discharged at 2C, 5C, 10C and 20C were measured, while charging the battery at 1C each time. The results are shown in FIG. 3. In FIG. 3, the horizontal axis indicates the discharge current density and the vertical axis indicates the percentage based on the discharge capacity (discharge efficiency) when discharged at 1C. Here, “1C” refers to a current density when the total capacity of a battery was discharged within 1 hour. The unit of “mA/cm²” indicates the current density.

### Comparative Example 1

A battery was prepared in the same manner as Example 1 with the exception that the positive electrode was prepared without providing a conductive auxiliary layer. This battery of Comparative Example 1 in which no conductive auxiliary layer was provided was charged at 1C, and the discharge capacity thereof when discharged at 1C was measured. Thereafter, the discharge capacities thereof when discharged at 2C, 5C, 10C and 20C were measured, while charging the battery at 1C each time. The results are shown in FIG. 3.

### Example 2

In the same manner as Example 1, a conductive auxiliary layer with a film thickness of 5 μm was obtained using the granular carbon (#25: manufactured by Mitsubishi Chemical Corporation and having a DBP absorption of 69 cm³/100 g).

8 g of PTMA was added to 48.6 g of water, and the mixture was dispersed using a bead mill, thereby obtaining a polymer radical dispersion liquid. Thereafter, 2.85 g of VGCF, 0.11 g of polytetrafluoroethylene (manufactured by Daikin Industries, Ltd. and hereafter referred to as “PTFE”) serving as a binder and 0.46 g of carboxymethyl cellulose (manufactured by Daicel Chemical Industries, Ltd. and hereafter referred to as “CMC”) serving as a thickener were added thereto, and the mixture was then stirred until a uniform dispersion was obtained using a dispersion stirrer, thereby yielding an ink for electrode. The obtained ink for electrode was applied onto the conductive auxiliary layer, which was prepared in the same manner as Example 1 using the granular carbon #25, and then dried using a vacuum oven, followed by a pressing process, thereby obtaining a positive electrode having a dimension of 25 mm (width)×16 mm (length).

A thin organic radical battery (58 mm (length)×52 mm (width)×0.3 mm (thickness)) was prepared using the positive electrode prepared as described above in the same method as Example 1.

This battery of Example 2 using the granular carbon as the carbon for a conductive auxiliary layer was charged at 1C, and the discharge capacity thereof when discharged at 1C was measured. Thereafter, the discharge capacities thereof when discharged at 2C, 5C, 10C and 20C were measured, while charging the battery at 1C each time. The results are shown in FIG. 4. In FIG. 4, as in FIG. 3, the horizontal axis indicates the discharge current density and the vertical axis indicates the percentage based on the discharge capacity when discharged at 1C.

### Example 3

A carbon ink for a conductive auxiliary layer was prepared in the same method as Example 1 using a graphite (SGP-3, manufactured by SEC Carbon Ltd.) as the carbon for a conductive auxiliary layer, and was applied uniformly onto an aluminum foil and dried, thereby obtaining a conductive auxiliary layer. Thereafter, a positive electrode was obtained by the same method as Example 2.

A thin organic radical battery (58 mm (length)×52 mm (width)×0.3 mm (thickness)) which employed the above-mentioned conductive auxiliary layer using the graphite was prepared in the same method as Example 2.

This battery of Example 3 using the graphite as the carbon for a conductive auxiliary layer was charged at 1C, and the discharge capacity thereof when discharged at 1C was measured. Thereafter, the discharge capacities thereof when discharged at 2C, 5C, 10C and 20C were measured, while charging the battery at 1C each time. The results are shown in FIG. 4.

### Example 4

A carbon ink for conductive auxiliary layer was prepared in the same method as Example 1 using a carbon fiber (VGCF) (fibrous carbon) as carbon for a conductive auxiliary layer, and was applied uniformly onto an aluminum foil and dried, thereby obtaining a conductive auxiliary layer. Thereafter, a positive electrode was obtained by the same method as Example 2.

A thin organic radical battery (58 mm (length)×52 mm (width)×0.3 mm (thickness)) which employed the above-mentioned conductive auxiliary layer using the carbon fiber was prepared in the same method as Example 2.

This battery of Example 4 using the carbon fiber as the carbon for a conductive auxiliary layer was charged at 1C, and the discharge capacity thereof when discharged at 1C was measured. Thereafter, the discharge capacities thereof when discharged at 2C, 5C, 10C and 20C were measured, while charging the battery at 1C each time. The results are shown in FIG. 4.

### Comparative Example 2

A carbon ink for a conductive auxiliary layer was prepared in the same method as Example 1 using a conductive carbon (a general-purpose conductive carbon #3050 manufactured by Mitsubishi Chemical Corporation and having a DBP absorption of 175 cm³/100 g) as the carbon for a conductive auxiliary layer, and was applied uniformly onto an aluminum foil and dried, thereby obtaining a conductive auxiliary layer.

A thin organic radical battery (58 mm (length)×52 mm (width)×0.3 mm (thickness)) which employed the above-mentioned conductive auxiliary layer using the conductive carbon #3050 was prepared in the same method as Example 2.

This battery of Comparative Example 2 using the conductive carbon as the carbon for a conductive auxiliary layer was charged at 1C, and the discharge capacity thereof when discharged at 1C was measured. Thereafter, the discharge capacities thereof when discharged at 2C, 5C, 10C and 20C were measured, while charging the battery at 1C each time. The results are shown in FIG. 4.

### Example 5

In the same manner as Example 1, a conductive auxiliary layer with a film thickness of 1.5 μm after drying was obtained using the granular carbon (#25: manufactured by Mitsubishi Chemical Corporation and having a DBP absorption of 69 cm3/100 g). Thereafter, a positive electrode was obtained by the same method as Example 2.

A thin organic radical battery (58 mm (length)×52 mm (width)×0.3 mm (thickness)) which employed the above-mentioned positive electrode was prepared in the same method as Example 2.

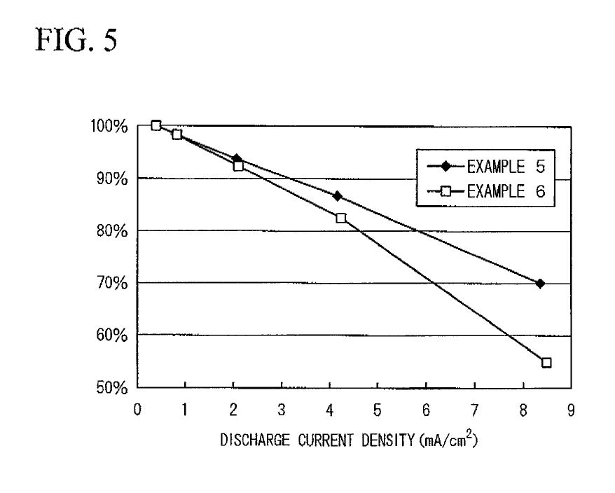

This battery of Example 5 using the above-mentioned conductive auxiliary layer was charged at 1C, and the discharge capacity thereof when discharged at 1C was measured. Thereafter, the discharge capacities thereof when discharged at 2C, 5C, 10C and 20C were measured, while charging the battery at 1C each time. The results are shown in FIG. 5.

### Example 6

In the same manner as Example 1, a conductive auxiliary layer with a film thickness of 5 μm after drying was obtained using the granular carbon (#25: manufactured by Mitsubishi Chemical Corporation and having a DBP absorption of 69 cm³/100 g). Thereafter, a positive electrode was obtained by the same method as Example 2.

A thin organic radical battery (58 mm (length)×52 mm (width)×0.3 mm (thickness)) which employed the above-mentioned positive electrode was prepared in the same method as Example 2.

This battery of Example 6 using the above-mentioned conductive auxiliary layer was charged at 1C, and the discharge capacity thereof when discharged at 1C was measured. Thereafter, the discharge capacities thereof when discharged at 2C, 5C, 10C and 20C were measured, while charging the battery at 1C each time. The results are shown in FIG. 5.

From FIG. 3, it is apparent that the rate characteristics differed greatly depending on the presence and absence of a conductive auxiliary layer, and the battery having a conductive auxiliary layer exhibited high rate characteristics.

From FIG. 4, it is clear that when comparing the battery of Example 2 with a conductive auxiliary layer mainly composed of granular carbon having a DBP absorption of not more than 110 cm³/100 g, the battery of Example 3 with a conductive auxiliary layer mainly composed of graphite and the battery of Example 4 with a conductive auxiliary layer mainly composed of a carbon fiber, with the battery of Comparative Example 2 with a conductive auxiliary layer mainly composed of a conductive carbon, the rate characteristics differed greatly, and the batteries of Examples 2 to 4 exhibited higher rate characteristics than the battery of Comparative Example 2. In addition, among the batteries of Examples 2 to 4, the battery of Example 2 with a conductive auxiliary layer mainly composed of granular carbon having a DBP absorption of not more than 110 cm³/100 g exhibited the highest rate characteristics.

From FIG. 5, it is evident that the rate characteristics of the battery of Example 5 in which the film thickness after drying was adjusted to 1.5 μm was higher than the rate characteristics of the battery of Example 6 in which the film thickness after drying was adjusted to 5 μm.

### INDUSTRIAL APPLICABILITY

Since the secondary battery of the present invention is a thin-layer type and can achieve high rate characteristics, it can be used as a secondary battery that requires a high output, and can contributes to the size and weight reduction of various electronic equipment.

### DESCRIPTION OF THE REFERENCE

1: Radical material/conducting additive positive electrode
2: Conductive auxiliary layer
3: Positive electrode current collector
4: Positive electrode lead
5: Separator
6: Negative electrode lead
7: Negative electrode
8: Negative electrode current collector
9: Exterior aluminum laminate

1. A secondary battery in which at least one of a positive electrode and a negative electrode uses, as an electrode active material, a polymer radical material and a conducting additive exhibiting electrical conductivity,
the secondary battery comprising a conductive auxiliary layer provided between a current collector and the polymer radical material/conducting additive electrode which is mainly composed of any one of graphite, fibrous carbon or a granular carbon having a DBP absorption of not more than 110 cm³/100 g.

2. The secondary battery according to claim 1, wherein the conductive auxiliary layer is mainly composed of a granular carbon having a DBP absorption of not less than 30 cm³/100 g and not more than 110 cm³/100 g.

3. The secondary battery according to claim 1, wherein the mass ratio of graphite, fibrous carbon or a granular carbon having a DBP absorption of not more than 110 cm³/100 g of the conductive auxiliary layer is not less than 50% and not more than 95%.

4. The secondary battery according to claim 1, wherein the film thickness of the conductive auxiliary layer after drying is not more than 6 μm.

5. The secondary battery according to claim 1, wherein the polymer radical material is a polynitroxyl radical compound having a nitroxyl radical structure represented by a general formula (1) within a repeating unit.

6. The secondary battery according to claim 5, wherein the polynitroxyl radical compound is poly(4-methacryloyloxy-2,2,6,6-tetramethylpiperidine-1-oxyl), poly(4-acryloyloxy-2,2,6,6-tetramethylpiperidine-1-oxyl), or a copolymer containing these as the components thereof.

7. The secondary battery according to claim 5, wherein the polynitroxyl radical compound is poly(4-vinyloxy-2,2,6,6-tetramethylpiperidine-1-oxyl) or a copolymer containing this as the component thereof.

8. The secondary battery according to claim 5, wherein the polynitroxyl radical compound has a cross-linked structure.

9. The secondary battery according to claim 1, wherein the secondary battery is a lithium secondary battery.
